(19) United States
(12) Patent Application Publication
(10) Pub. No.: US 2019/0180327 A1
(43) Pub. Date: Jun. 13, 2019

(54) SYSTEMS AND METHODS OF TOPIC MODELING FOR LARGE SCALE WEB PAGE CLASSIFICATION

(71) Applicants: Arun Balagopalan, San Franciso, CA (US); Hardik Shah, Sunnyvale, CA (US); Carolina Galleguillos, San Francisco, CA (US)

(72) Inventors: Arun Balagopalan, San Franciso, CA (US); Hardik Shah, Sunnyvale, CA (US); Carolina Galleguillos, San Francisco, CA (US)

(21) Appl. No.: 15/836,014

(22) Filed: Dec. 8, 2017

(51) Int. Cl. G06Q 30/02; G06F 17/30

(52) U.S. Cl. CPC G06Q 30/0263; G06F 17/3069; G06F 17/30864; G06Q 30/0277

(57) ABSTRACT

A method of classifying webpages using a data processing system includes generating a plurality of topic models from a first plurality of training documents. The method further includes performing inference using the plurality of topic models on a second plurality of training documents, to generate a first set of feature vectors and a second set of feature vectors. The method further includes performing supervised classification of a third plurality of training documents using the first set of feature vectors, to generate a plurality of candidate topic models. The method further includes evaluating the plurality of candidate topic models using the second set of feature vectors and storing, in a production model datastore, at least some of the plurality of candidate topic models as production topic models, responsive to the evaluation, wherein the first plurality of training documents comprise text obtained from an inventory of web pages.

### TECHNICAL FIELD

The present invention relates to the field of online advertising, and in particular to systems and methods for automatically classifying large numbers of web pages.

### BACKGROUND

Advertising technology (“ad tech”) companies may connect brand advertisers with their audiences through targeted and brand safe campaigns, at scale. Such ad tech companies may analyze millions of videos and web pages to tag content with appropriate labels to allow advertisements to be selected for those videos and web pages.

For most web pages, the text on the page provides a very strong signal to classify the type of content on the page as a whole. Accordingly, systems and methods capable of automatically and reliably performing large scale classification of large databases of web pages are desired.

### SUMMARY

In accordance with one aspect of the disclosure, a non-transitory, machine-readable medium on which are stored instructions, comprising instructions which, when executed, cause a data processing system to generate a plurality of topic models from a first plurality of training documents and perform inference using the plurality of topic models on a second plurality of training documents, to generate a first set of feature vectors and a second set of feature vectors. The instructions further cause the data processing system to perform supervised classification of a third plurality of training documents using the first set of feature vectors, to generate a plurality of candidate topic models, and evaluate the plurality of candidate topic models using the second set of feature vectors. The instructions further cause the data processing system to store at least some of the plurality of candidate topic models as production topic models in a production model datastore, responsive to the evaluation, wherein the first plurality of training documents comprise text obtained from inventory of web pages.

In accordance with another aspect of the disclosure, a data processing system, for generating and updating topic models for classifying web pages, is disclosed. The data processing system includes one or more processors and a non-transitory memory readable by and operatively associated with at least one of the one or more processors. The non-transitory memory stores instructions, which, when executed, cause at least one of the one or more processors to generate a plurality of topic models from a first plurality of training documents and perform inference using the plurality of topic models on a second plurality of training documents, to generate a first set of feature vectors and a second set of feature vectors. The instructions further cause at least one of the one or more processors to perform supervised classification of a third plurality of training documents using the first set of feature vectors, to generate a plurality of candidate topic models, and evaluate the plurality of candidate topic models using the second set of feature vectors. The instructions further cause at least one of the one or more processors to store at least some of the plurality of candidate topic models as production topic models in a production model datastore, responsive to the evaluation, wherein the first plurality of training documents comprise text obtained from inventory of web pages.

In accordance with yet another aspect of the disclosure, a method of classifying webpages is disclosed. The method includes generating, in a data processing system, a plurality of topic models from a first plurality of training documents. The method further includes performing, by the data processing system, inference using the plurality of topic models on a second plurality of training documents, to generate a first set of feature vectors and a second set of feature vectors. The method further includes performing, by the data processing system, supervised classification of a third plurality of training documents using the first set of feature vectors, to generate a plurality of candidate topic models. The method further includes evaluating, by the data processing system, the plurality of candidate topic models using the second set of feature vectors and storing, in a production model datastore, at least some of the plurality of candidate topic models as production topic models, responsive to the evaluation, wherein the first plurality of training documents comprise text obtained from an inventory of web pages.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings:

FIG. 1 is a block diagram illustrating a general topic modeling pipeline, according to an embodiment of the disclosure.

FIG. 2 is a block diagram illustrating a classifier training system, according to an embodiment of the disclosure.

FIG. 3 is a block diagram illustrating a load-balanced system for deploying trained topic models and classifiers, according to an embodiment of the disclosure.

FIG. 4 is a block diagram illustrating a topic discovery pipeline run on trained topic models to produce production models, according to an embodiment of the disclosure.

FIG. 5 is a block diagram illustrating a programmable device, one or more of which may be utilized in performing the techniques and/or embodying the systems illustrated in FIGS. 1-4.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a computer system” can refer to a single computer or a plurality of computers working together to perform the function described as being performed on or by a computer system. Similarly, “a machine readable medium” can refer to a physical medium or a plurality of physical media that together store data or instructions to cause a machine to perform functions that are described as being performed on or by the machine. Particularly, a “computer-readable medium” and/or a “machine-readable medium” refers to such media, which is non-transitory media.

As described below, systems build models from massive datasets of web pages to classify accurately a continuous stream of web pages into relevant categories, using topic modeling algorithms.

Embodiments described below are systems for training and deploying classifiers using topic modeling. One group of embodiments provides a supervised classification framework. Another group of embodiments provides an unsupervised topic discovery framework.

Supervised classification is most commonly used when the training categories are predefined, and come with sufficiently large collections of labeled documents. Unsupervised classification is typically used as a system that can discover categories automatically, and classify pages with newly discovered categories. Embodiments of the techniques described below use a combination of supervised and unsupervised classification techniques.

In one embodiment, these techniques enhance the usefulness of general online video classification for online advertising; however, the same or similar techniques may be applied to other applications, such as organization of personal or commercial text.

In these embodiments, a training pipeline is divided into two main parts: (a) training topic models for feature extraction, and (b) training classifiers for content categories.

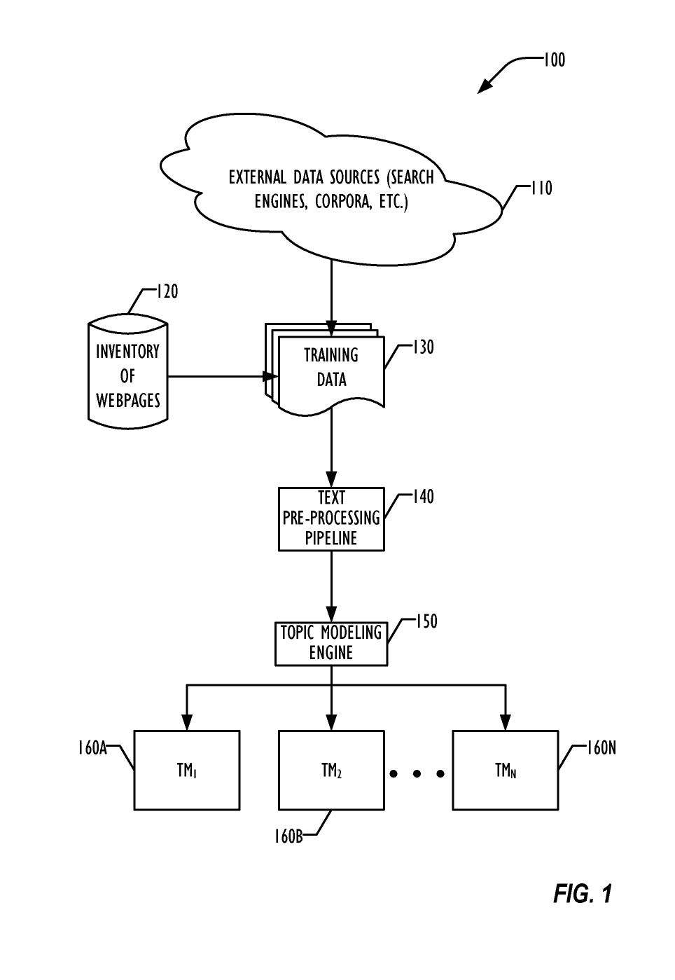

FIG. 1 is a block diagram illustrating a general topic modeling pipeline 100 according to one embodiment. This part of the framework does not require labeled documents. The training data 130 for topic modeling comes primarily from an internal inventory 120 of crawled web pages, typically millions of web pages. Such large text datasets are well suited for the application of topic modeling and similar supervised learning techniques. In some embodiments, data 110 from external sources, such as various text corpora and/or search engines, may be included to improve the diversity of the training data. Any other sources of textual training data may be used as desired, whether internally maintained or obtained from external sources.

Before running topic modeling, the training data documents 130 may be pre-processed in a pre-processing pipeline 140 to clean and normalize the training data. In one embodiment, the pre-processing includes standard text processing functionality. In some embodiments, the pre-processing includes specialized steps to improve topic modeling output. For example, the pre-processing pipeline may include functionality to perform one or more of (a) selective stemming, (b) generic and domain-based stopword filtering, (c) web page noise text removal, (d) vocabulary-based filtering, and (e) document normalization and outlier removal. These pre-processing steps are illustrative and by way of example only, and other additional and/or alternative text pre-processing functionality may be applied in the text pre-processing pipeline 140.

In one embodiment, once processed through the pre-processing pipeline 140, the cleaned documents may be randomly split into multiple training datasets for topic modeling. In some embodiments, the multiple training datasets may be overlapping datasets. Splitting the data into multiple datasets allows the topic modeling system to learn a diverse set of topic models that have better recall statistics compared to a monolithic model.

The multiple training datasets are then processed by the topic modeling engine 150 to produce topic models. Large datasets, such as those used for online advertising, may be so large that the computational burden on a single machine, which is executing creation of a topic model, may be excessive. Therefore, the topic modeling engine 150 may be implemented as a parallel architecture of topic modeling engines implemented on a cluster of machines, which process the multiple training datasets in parallel. The result of the topic modeling engine 150 is a collection of topic models 160A-160N. Any number of topic models 160 produced by the topic modeling engine 150 as desired. In some examples, a Latent Dirichlet Allocation technique may be used by the topic modeling engine 150 to create the topic models; however, the topic modeling engine 150 may use any acceptable technique for topic modelling, known in the art. Particularly, Latent Dirichlet Allocation (or “LDA”) techniques are a type of generative statistical model, well known in the art that allows sets of observations to be explained by unobserved groups, which may explain why some parts of the data are similar. For example, like the word-based structures discussed above, if observations are words collected into documents, LDA may posit that each document is a mixture of a small number of topics and that the creation of each word, within the document, is attributable to one of the document's topics. Of course, other types of machine learning and natural language processing techniques may be used as desired.

In machine learning and natural language processing, a topic model is a type of statistical model for discovering the underlying semantic structure of a collection of documents, finding the abstract “topics” that occur in the collection of documents. A topic is typically expressed as a distribution over a fixed vocabulary. Intuitively, given that a document is about a particular topic, one would expect particular words to appear in the document more or less frequently: “dog” and “bone” will appear more often in documents about dogs, “cat” and “meow” will appear in documents about cats, and “the” and “is” will appear equally in both. A document typically concerns multiple topics in different proportions; thus, in a document that is 10% about cats and 90% about dogs, there would probably be about 9 times more dog words than cat words. A topic model captures this intuition in a mathematical framework, which allows examining a set of documents and discovering, based on the statistics of the words in each, what the topics might be and what each document's balance of topics is. For more information on topic models, see “Introduction to Probabilistic Topic Models” by David M. Blei, Comm. ACM Vol. 44, No. 4, pp. 77-84 (April 2012), which is incorporated by reference herein in its entirety for all purposes.

Although the system 100 is illustrated in FIG. 1 as directly connected, any or all of the elements of the system 100 may be connected to the other elements by one or more networks, and need not reside at a common location. For example, the topic modeling engine 150 may be implemented by a collection of network connected computers at one or more locations connected by one or more networks. In another example, the internal inventory 120 may be stored in any desired or convenient manner, including multiple storage devices maintained at one or more network-connected locations. No particular form of storage is implied by FIG. 1.

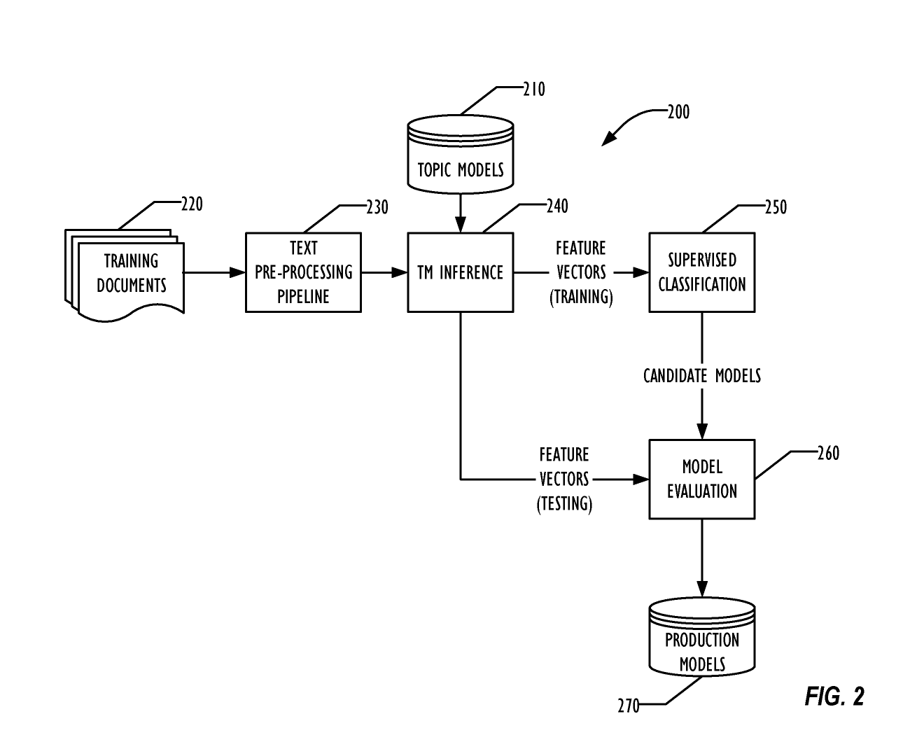

The topic models 160 are then used to train classifiers to categorize web pages in a supervised classifier system 200, illustrated in FIG. 2. The topic models 160 are stored in a database of topic models 210. As in the framework of FIG. 1, training documents 220 are used. In this supervised framework 200, some of the training documents have been labeled for a category, using categories typically obtained from crowdsourcing, external datasets, or both. In a typical implementation, the training documents 220 comprise a dataset of both web pages labeled with the training categories and web pages that do not belong to any of the training categories. The latter provide negative data for the training classifier system 200.

As with the training data 130 of FIG. 1, the training documents 220 of FIG. 2 may be processed by a text pre-processing pipeline 230. In one embodiment, the same types of pre-processing may be performed by the classifier system 200 as in the topic modeling pipeline 100 of FIG. 1. In other embodiments, the text pre-processing pipeline 230 may employ at least some additional or alternative pre-processing techniques that are different from those used by the text pre-processing pipeline 150.

In inference engine 240, the previously trained database of topic models 210 is used for running one or more topic inference algorithms on the labeled documents 220 that have been pre-processed by text pre-processing engine 230. Inference is a technique for deducing properties of an underlying distribution by analysis of data. In the present context, the inference engine 240 is used to extract topic distributions in documents to help evaluate the topic models and select which models should be used in production. Inference is a statistical technique, engine, and/or algorithm known in the art, which involves application of logical rules to a knowledge base (e.g., labeled documents 220) to deduce new information. Embodiments of the inference engine may use any desired inference algorithms.

This can be seen as a feature extraction procedure, where the topics are features and the corresponding document-topic probabilities are the feature values. Therefore, in one embodiment, for each topic model of the database 210, the inference engine 240 produces a representation of the pre-processed labeled dataset 220 in the form of a distribution of topics.

The output of the topic model inference engine 240 may then be split into two sets: a training set of feature vectors and a testing set of feature vectors. The training set may then be processed by a supervised classification engine 250 to train individual classifiers from the output of each topic model. In some embodiments, features from different topic models may be combined, and ensemble learning techniques may be used in the same framework. The classification engine 250 produces one or more composite models that are candidates for production topic models. These candidate models may then be used by the model evaluation engine 260 for processing the testing set of feature vectors, evaluating the composite models produced by the supervised classification engine 250 against the testing set using standard machine learning techniques. The best performing of the composite models may then be stored in a database 270 of production models. In one embodiment, the evaluation engine 260 evaluates the candidate models by using the models to classify testing documents for which the classification is already known and comparing the classification produced by the candidate models with the true classification. In one embodiment, if the candidate model has an accuracy rate of at least 80% it is accepted as a production model. Other threshold values may be used as desired.

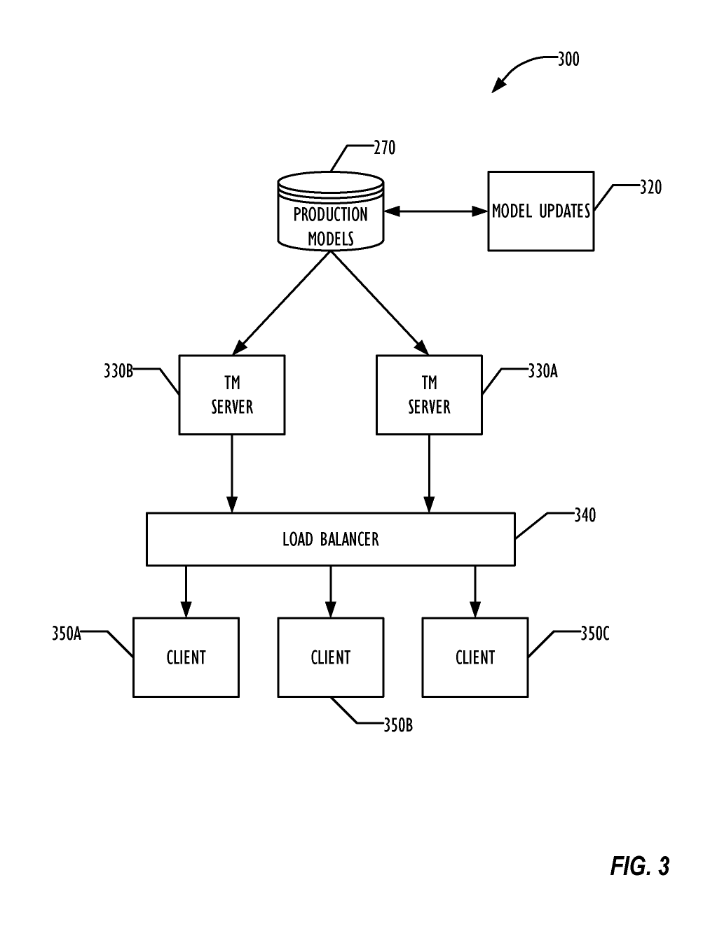

FIG. 3 is a block diagram illustrating a system 300 for using the production models and classifiers 270 in a web-based media context. As illustrated, the trained production topic models and classifiers are deployed on topic model servers 330, avoiding the overhead of loading the large models into memory every time a prediction request is issued by a client. (A topic model may be on the order of 200 MB.) In one embodiment, multiple topic model servers 330 may be used, behind a load balancer 340. As illustrated, two topic model servers 330A and 330B are illustrated, but embodiments may deploy any desired number of topic model servers 330. Load balancer 340 may use any desired load balancing technique.

In one embodiment, each topic model server 330 may hold a subset of all of the topic models, and the load balancer 340 routes client queries to the appropriate server 330 based on the topic models served by the server 330. In other embodiments, each topic model server 330 may hold all of the topic models 270, and requests are routed by the load balancer 340 based on the load of the various servers 330.

Thus, when a client 350 (as illustrated, three clients 350A-350C) issues requests for topic distributions on a web page, the request is forwarded to one of the topic model servers 330, topic inference is performed using the models and the results are returned to the client 350. As illustrated, three clients 350A-350C are illustrated for clarity, but any number of clients 350 may use the system 300 as desired. The clients 350 then use the topic distributions to classify web pages from the web page inventory.

Due to the dynamic nature of web page inventory, models preferably are updated as frequently as possible with new data. This is especially true for categories such as “News” where content is constantly changing. To ensure accuracy, embodiments may monitor model performance constantly using crowd-sourced evaluation. In such an evaluation, sample pages are submitted to the crowd for quality assurance. For example, a web page may be classified as “basketball” by the topic model(s). The crowd may be asked to evaluate that classification. If the crowd indicates that the web page is not properly classified as basketball, either because the web page is not about basketball, or because the meaning of “basketball” has shifted and the model is no longer applicable, the model can be flagged to be updated.

In general, models in production may be added, removed, or updated. When this happens, the changes are pushed from the model store 270 to the servers 330. An update (illustrated in FIG. 3 in block 320) usually means replacing existing models with better models, although embodiments may update existing models instead of replacing them. Some possible scenarios would indicate a reason to perform model updates are:

General improvements to the topic modeling and/or classifier algorithms that would need retraining existing models;

Automatic retraining of models periodically with fresh or better data to prevent staleness, using a retraining window that may be different for different categories;

Automatic retraining of models if performance deteriorates beyond expected parameters, measured using crowd-sourced evaluation results; and

Pipeline process improvements that propagate to models (a better stop word filter for example).

These scenarios are illustrative and by way of example only, and there may be another number of other scenarios that would drive removing, updating, or replacing an existing model or adding additional models.

In the discussion above, an architecture was described for supervised training of classifiers from topic modeling with handpicked training classes. Notably, this framework generally works best when a large number of training examples or documents for the chosen category are available.

In the discussion below, a similar framework is described that can be used to automatically learn new categories from data and build classifiers for them. Such a framework can allow building a system that adapts and improves when data is constantly changing, as is the case with web page classification.

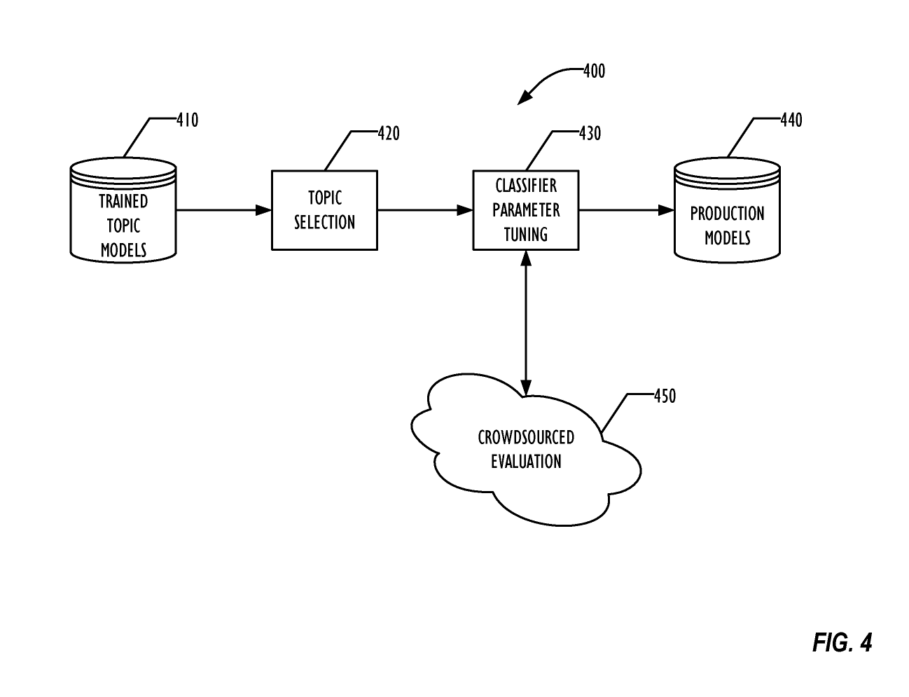

FIG. 4 is a block diagram illustrating a topic discovery pipeline according to one embodiment to augment topic models that may have been generated in the supervised training system described above. The topic discovery pipeline may be run independently on topic models produced by the training pipeline of FIGS. 1-3.

In one embodiment, each topic in a topic model may be evaluated based on the following criteria:

1) Topic coherence: How strongly does the topic distribution capture a coherent, real-world topic?

2) Topic uniqueness: How unique is the topic in relation to topics from other models that are already in use?

3) Topic recall: What would be the recall improvement from using this topic?

These criteria are described in more detail below. Other criteria may be used as desired.

In practice, the quality of topics discovered by topic modeling shows wide variation. Typically, the training data 130 comes mainly from text scraped off web pages, with little overall structure, and potentially including spam text and/or webpage noise (navigational elements, advertising, etc.). While some of these issues may be mitigated to a certain extent in the pre-processing pipeline 140, the amount of noise in the “cleaned” web pages may still be quite high. This can lead to topics that are often incoherent to a human judge, which may indicate that the topics are less than optimal features for classification.

For example, a coherent topic may include the words fish, fishing, shark, whale, sea, dolphin, catch, jaw, water, and ocean as modes of the topic distribution. All of the words are easily seen as related. An example of an incoherent topic may be the words cole, loui, born, lover, smile, guardian, trust, nat, keyshia, and crooked. While these words may have been found together with some frequency, imagining a coherent theme or connection between the words is at best difficult. These are merely examples of topic groups, and topics models generated by the system 100 of FIGS. 1-3 may exhibit a wide range of coherency or incoherency. In general, however, the more coherent the topic is, the more likely the topic will be useful for categorizing a web page.

To evaluate topic coherence, the following techniques may be used in some embodiments:

1) Search index statistics and natural language processing techniques can be used to score the similarity of top words in topics.

2) Crowdsourced evaluation. In such an embodiment, a collection of words may be provided to the crowd, asking the crowd how coherent the collection of words is.

Of course, other techniques may be used as desired.

Topics in separately trained models do not necessarily have a direct correspondence between them, even if they are trained on the same data. The uniqueness of a topic with respect to topics from other models can be determined by computing mutual information scores. That is, if a “discovered” topic has low mutual information scores with topics from past models on a large enough collection of documents, then that topic can be considered unique. Having relatively unique topics is generally more useful than having numerous topics that are correlated or overlapping, for example.

In one embodiment, crowdsourcing may be used to evaluate uniqueness, by asking the crowd whether two sets of words corresponding to two models are similar. If the crowdsourced sets of words are similar, the topics may be considered not unique. In other embodiments, uniqueness may be evaluated algorithmically, without crowd sourcing the evaluation.

However, topics that are correlated with existing topics (and thus have low uniqueness), may still improve overall recall. This is especially true if the correlated topics are broad. A new topic, although only slightly different from previous topics, could be a useful feature to classify for pages where the correlations do not show. In other words, a topic is useful if it is present in a significant number of pages that do not contain related topics.

Topics that pass all the above criteria (or any other criteria that may be used) may be used for building new classifiers for either existing or newly discovered categories. In FIG. 4, this is the part of the pipeline 400 following the topic selection process. The challenge here is the lack of labeled training data to build classifiers for the new topics, as is done in the supervised training framework discussed above.

To get around this problem, embodiments may exploit the fact that good topics are strong, stand-alone classifiers. For each discovered topic, an embodiment may employ a decision stump binary classifier that predicts whether a document “contains” the topic, depending on the topic's contribution to the document. For example, if the decision stump classifier for topic T has a threshold S=0.2, then any document that has topic T's proportion >=0.2 results in a positive prediction and negative otherwise.

The threshold parameter S may initially be hand-tuned or adopted from a pre-trained classifier for a similar label. Running this classifier on holdout data and doing crowd-sourced evaluation can help to further improve parameter values.

Thus, in FIG. 4, a collection of trained topic models 410 may be run through a topic selection process 420 to select models for evaluation. In a classification tuning engine 430, parameters for the classifier may be trained, using a crowd-sourced evaluation 450. The result of the classifier tuning engine 430 may then be used to update or add to the production models database 440. Although this framework of training classifiers from topic modeling results is simpler compared to the earlier supervised setup, in practice the overall performance in most cases is similar.

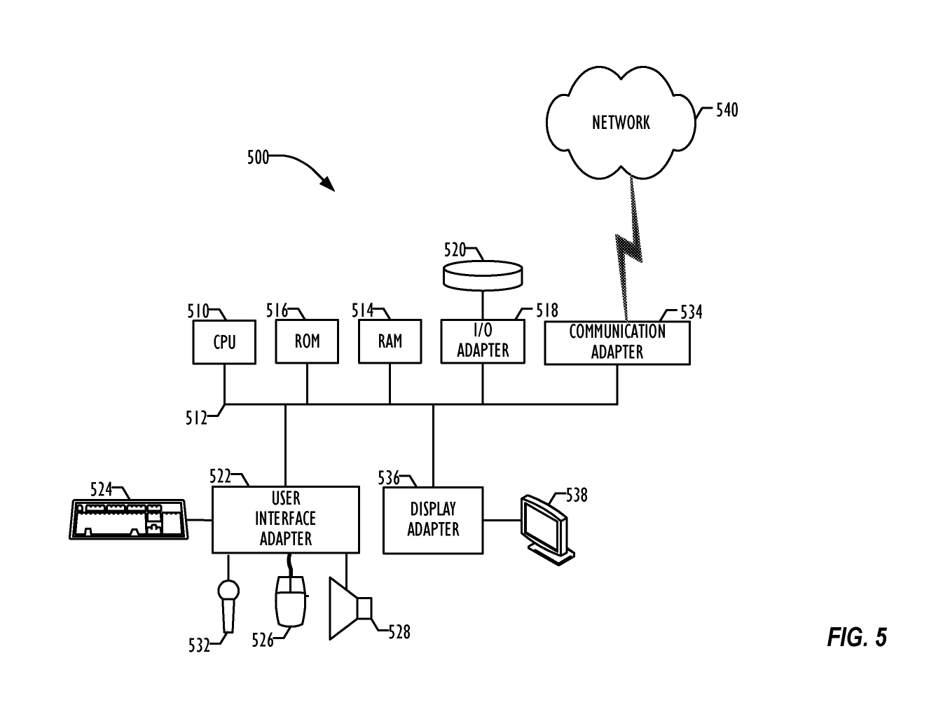

FIG. 5 is an overview illustrating a data processing system according to one embodiment suitable for performing the techniques described above. In FIG. 5, a typical hardware configuration of a workstation in accordance with one embodiment has a central processing unit 210, such as a microprocessor, and a number of other units interconnected via a system bus 212. Although described herein as a workstation, similar hardware configurations may be deployed as a server. Such hardware may be used for performing any or all of the processing described above. Although for clarity, a single instance of each element is illustrated in FIG. 5, multiple instances may be used as desired, implemented as a single device or a plurality of devices. Although as illustrated a bus architecture is used for connecting elements, other architectures may be used as desired.

The workstation shown in FIG. 5 includes a Random Access Memory (RAM) 514, Read Only Memory (ROM) 516, an I/O adapter 518 for connecting peripheral devices such as disk storage units 520 to the bus 512, a user interface adapter 522 for connecting a keyboard 524, a mouse 526, a speaker 528, a microphone 532, and/or other user interface devices such as a touch screen (not shown) to the bus 512, a communication adapter 534 for connecting the workstation to a communication network 535 (e.g., a data processing network) and a display adapter 536 for connecting the bus 512 to a display device 538. The workstation may have resident thereon any desired operating system. In some embodiments, hardware elements illustrated in FIG. 5 may be virtualized and provided as part of a virtual machine. Some of the illustrated elements may be omitted or replaced with other elements as desired.

The various embodiments set forth herein may be implemented utilizing hardware, software, or any desired combination thereof. Similarly, any type of logic may be utilized which is capable of implementing the various functionality set forth herein.

Furthermore, the techniques described above can take the form of a computer program product comprising program modules accessible from a machine readable medium storing program code instructions for execution by or in connection with one or more computers such as the one illustrated in FIG. 5. For the purposes of this description, a machine readable medium can be any apparatus that can contain, store, communicate, propagate, or transport the program for use by or in connection with the computer 500. The medium can be an electronic, magnetic, optical, electromagnetic, infrared, or semiconductor system. Examples of a machine readable medium include a semiconductor or solid state memory, a removable memory such as a Universal Serial Bus (USB) device, a magnetic tape, a random access memory (RAM), a read-only memory (ROM), a rigid magnetic disk, and an optical disk. For purposes of this description, a machine readable medium may be a single physical medium or a collection of physical medium that together store the instructions for execution by one or more computers.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A non-transitory, machine-readable medium on which are stored instructions, comprising instructions which, when executed, cause a data processing system to:
generate a plurality of topic models from a first plurality of training documents;
perform inference using the plurality of topic models on a second plurality of training documents, to generate a first set of feature vectors and a second set of feature vectors;
perform supervised classification of a third plurality of training documents using the first set of feature vectors, to generate a plurality of candidate topic models;
evaluate the plurality of candidate topic models using the second set of feature vectors; and
store at least some of the plurality of candidate topic models as production topic models in a production model datastore, responsive to the evaluation,
wherein the first plurality of training documents comprise text obtained from an inventory of web pages.

2. The machine-readable medium of claim 1, wherein the instructions further comprise instructions, which, when executed, cause the data processing system to:
obtain production models from the production model datastore by a plurality of topic model servers; and
balance requests by classification clients for the production models from the plurality of topic model servers by a load balancer.

3. The machine-readable medium of claim 1, wherein the instructions further comprise instructions, which, when executed, cause the data processing system to update the production topic models.

4. The machine-readable medium of claim 1, wherein the instructions, which, when executed, cause the data processing system to update the production topic models comprise instructions that when executed cause the data processing system to:
provide web pages and a classification of the web pages by the production topic models to a crowd-sourcing system; and
receive an evaluation of the classification from the crowd-sourcing system.

5. The machine-readable medium of claim 1, wherein the instructions, which, when executed, cause the data processing system to update the production topic models comprise instructions, which, when executed, cause the data processing system to:
evaluate a topic coherence of the production topic models.

6. The machine readable medium of claim 1, wherein the instructions, which when executed, cause the data processing system to update the production topic models comprise instructions, which, when executed cause the data processing system to:
evaluate a topic uniqueness of the production topic models.

7. The machine readable medium of claim 1, wherein the instructions, which when executed, cause the data processing system to update the production topic models comprise instructions, which, when executed, cause the data processing system to:
evaluate a topic recall quality of the production topic models.

8. A data processing system for generating and updating topic models for classifying web pages, comprising:
one or more processors;
a non-transitory memory readable by and operatively associated with at least one of the one or more processors, the non-transitory memory storing instructions, which, when executed, cause at least one of the one or more processors to:
generate a plurality of topic models from a first plurality of training documents;
perform inference using the plurality of topic models on a second plurality of training documents, to generate a first set of feature vectors and a second set of feature vectors;
perform supervised classification of a third plurality of training documents using the first set of feature vectors, to generate a plurality of candidate topic models;
evaluate the plurality of candidate topic models using the second set of feature vectors; and
store at least some of the plurality of candidate topic models as production topic models in a production model datastore, responsive to the evaluation,
wherein the first plurality of training documents comprise text obtained from an inventory of web pages.

9. The data processing system of claim 8, wherein the instructions further, when executed, cause at least one of the processors to:
obtain production models from the production model datastore by a plurality of topic model servers; and
balance requests by classification clients for the production models from the plurality of topic model servers by a load balancer.

10. The data processing system of claim 8, wherein the instructions further, when executed, cause at least some of the processors to update the production topic models.

11. The data processing system of claim 8, wherein the instructions, which, when executed, cause the data processing system to update the production topic models comprise instructions, which, when executed, cause at least some of the processors to:
provide web pages and a classification of the web pages by the production topic models to a crowd-sourcing system; and
receive an evaluation of the classification from the crowd-sourcing system.

12. The data processing system of claim 8, wherein the instructions, which, when executed, cause the data processing system to update the production topic models comprise instructions, which, when executed, cause at least some of the processors to:
evaluate a topic coherence of the production topic models.

13. The data processing system of claim 8, wherein the instructions, which when executed, cause the data processing system to update the production topic models comprise instructions, which, when executed, cause at least some of the processors to:
evaluate a topic uniqueness of the production topic models.

14. The data processing system of claim 8, wherein the instructions, which, when executed, cause the data processing system to update the production topic models comprise instructions, which, when executed, cause at least some of the processors to:
evaluate a topic recall quality of the production topic models.

15. A method of classifying web pages, comprising:
generating, in a data processing system, a plurality of topic models from a first plurality of training documents;
performing, by the data processing system, inference using the plurality of topic models on a second plurality of training documents, to generate a first set of feature vectors and a second set of feature vectors;
performing, by the data processing system, supervised classification of a third plurality of training documents using the first set of feature vectors, to generate a plurality of candidate topic models;
evaluating, by the data processing system, the plurality of candidate topic models using the second set of feature vectors; and
storing, in a production model datastore, at least some of the plurality of candidate topic models as production topic models, responsive to the evaluation,
wherein the first plurality of training documents comprise text obtained from an inventory of web pages.
